(19) United States
(12) Patent Application Publication
(10) Pub. No.: US 2014/0234751 A1
(43) Pub. Date: Aug. 21, 2014

(54) SOLID OXIDE FUEL CELL AND MANUFACTURING METHOD THEREOF

(71) Applicant: SAMSUNG ELECTRO-MECHANICS CO., LTD., Suwon (KR)

(72) Inventors: Jong Ho CHUNG, Suwon, Gyunggi-do (KR); Sung Han KIM, Suwon, Gyunggi-do (KR); Jong Sik YOON, Suwon, Gyunggi-do (KR); Bon Seok KOO, Suwon, Gyunggi-do (KR)

(73) Assignee: SAMSUNG ELECTRO-MECHANICS CO., LTD., Suwon (KR)

(21) Appl. No.: 13/892,060

(22) Filed: May 10, 2013

(30) Foreign Application Priority Data
Feb. 21, 2013 (KR) 10-2013-0018700

(51) Int. Cl. H01M 8/02; H01M 8/10

(52) U.S. Cl. CPC H01M 8/0273; H01M 8/1016
USPC 429/485; 429/495; 429/535

(57) ABSTRACT

There are provided a solid oxide fuel cell capable of firmly sealing an anode while simultaneously securing rigidity of an anode support structure, and a manufacturing method thereof. The solid oxide fuel cell includes an electrolyte layer, a cathode provided on one surface of the electrolyte layer, an anode provided on the other surface of the electrolyte layer, and at least one reinforcing member disposed within the anode to reinforce rigidity thereof.

### CROSS-REFERENCE TO RELATED APPLICATIONS

This application claims the priority of Korean Patent Application No. 10-2013-0018700 filed on Feb. 21, 2013, in the Korean Intellectual Property Office, the disclosure of which is incorporated herein by reference.

### BACKGROUND OF THE INVENTION

1. Field of the Invention

The present invention relates to a solid oxide fuel cell and a manufacturing method thereof, and more particularly, to a solid oxide fuel cell capable of firmly sealing an anode while simultaneously securing rigidity of an anode support structure, and a manufacturing method thereof.

2. Description of the Related Art

A fuel cell is an apparatus directly converting the chemical energy of various fuels such as hydrogen, liquid natural gas (LNG), liquid petroleum gas (LPG), and the like, and air into electricity and heat using an electrochemical reaction. Unlike electricity generation technology according to the related art using fuel combustion, vapor generation, turbine driving, and generator driving processes, fuel cells are an electricity generation technology based on a new concept, which are not environmentally problematic and have a high degree of efficiency because they do not have a combustion process or a driving apparatus. Fuel cells emit air pollutants such as SOx, NOx, and the like in very small amounts and produce low levels of carbon dioxide. Therefore, fuel cells are a relatively clean means of generating electricity and have advantages such as low noise, a lack of vibrations, and the like.

Examples of fuel cells include various types of phosphoric acid fuel cell (PAFC), an alkali-like fuel cell (AFC), a proton exchange membrane fuel cell (PEMFC), a direct methanol fuel cell (DMFC), a solid oxide fuel cell (SOFC), and the like.

Of these, since solid oxide fuel cells (SOFCs) have a relatively low occurrence of overvoltage, based on activation polarization and low irreversible loss, SOFCs have high electricity generating efficiency. In addition, since SOFCs may use hydrogen as well as carbon or hydrocarbon-based fuels, there are a wide range of available fuels for use therewith, and due to the high degree of heat emitted according to electricity generation thereby, SOFCs have a high utility value.

The heat generated by solid oxide fuel cells may be used for reforming the fuel used therein and may also be used as an energy source in industry or for cooling in a cogeneration system. Therefore, solid oxide fuel cells are recognized as an electricity generation technology required in order to implement a hydrogen economy in the future.

Solid oxide fuel cells (SOFCs) are generally classified as flat-shaped solid oxide fuel cells and tube-shaped solid oxide fuel cells.

Of these, flat-shape solid oxide fuel cells have a separator, a unit cell, and a separator stacked therein in order. Flat-shape solid oxide fuel cells have higher performance and power density than tube-shaped solid oxide fuel cells and have a very simple manufacturing process. In particular, since electrodes and an electrolyte may be manufactured on a plane by tape casting, a doctor blade method, a screen printing method, or the like, manufacturing costs in manufacturing fuel cells are lower.

Unit cells of flat-shaped solid oxide fuel cells are configured to include an electrolyte membrane, a cathode disposed on one surface of the electrolyte membrane, and an anode disposed on the other surface of the electrolyte membrane. In addition, the cathode and the anode have respective current collectors disposed therein.

In such unit cells, when oxygen is supplied to the cathode and hydrogen is supplied to the anode, oxygen ions generated by a reduction reaction of the oxygen in the cathode pass through the electrolyte membrane, move to the anode, and react with the hydrogen supplied to the anode, thereby generating water. In this case, when electrons generated by the anode are delivered to the cathode and are consumed, the electrons flow into an external circuit, thereby producing electrical energy.

Meanwhile, in the case in which the anode is used as a support structure for the flat-shape solid oxide fuel cell, the anode requires a sintered body having mechanical strength as well as electrode activation or conductivity.

Therefore, in order to use the anode as a support structure, a method capable of securing mechanical strength in the anode is required.

In addition, the unit cell of the flat-shape solid oxide fuel cell may have a reduced thickness, and this may be problematic in terms of forming a seal between the anode and the cathode.

### RELATED ART DOCUMENT

Korean Patent Laid-Open Publication No. 2009-0012562

### SUMMARY OF THE INVENTION

An aspect of the present invention provides a solid oxide fuel cell capable of securing mechanical rigidity in an anode to allow the anode to be used as a support structure, and a manufacturing method thereof.

Another aspect of the present invention provides a solid oxide fuel cell capable of firmly and easily sealing an anode in a plate-shape solid oxide fuel cell, and a manufacturing method thereof.

According to an aspect of the present invention, there is provided a solid oxide fuel cell, including: an electrolyte layer; a cathode provided on one surface of the electrolyte layer; an anode provided on the other surface of the electrolyte layer; and at least one reinforcing member disposed within the anode to reinforce rigidity thereof.

The reinforcing member may be formed of a material having a higher degree of mechanical rigidity than that of the anode.

The electrolyte layer and the reinforcing member may be formed of the same material.

The anode may be formed of NiO/YSZ, and the reinforcing member may be formed of 3˜5 YSZ.

The reinforcing member may have at least one slit formed therein.

The reinforcing member may be a plurality of reinforcing members included in the anode, and the plurality of reinforcing members may be stacked and disposed so that directions of the at least one or more slits alternate with each other.

The electrolyte layer and the reinforcing member may be formed to have larger areas than that of the anode and may be protruded outwardly of edges of the anode, and the protruded portions may be bonded to each other to form a sealing part sealing a side of the anode.

The solid oxide fuel cell may further include a dense plate disposed at any one of one surface of the electrolyte layer and an external surface of the anode, and formed of the same material as the reinforcing material.

The electrolyte layer, the reinforcing member, and the dense plate may be formed to have a larger area than that of the anode and may be protruded outwardly of edges of the anode, and the protruded portions may be bonded to each other to form a sealing part sealing a side of the anode.

The dense plate may include at least one opening and the cathode may be attached to the electrolyte layer in the opening.

According to an aspect of the present invention, there is provided a solid oxide fuel cell, including: an electrolyte layer; a cathode provided on one surface of the electrolyte layer; an anode provided on the other surface of the electrolyte layer; and a dense plate disposed on one surface of the electrolyte layer and an external surface of the anode, wherein the electrolyte layer and the dense plate may be formed to have a larger area than that of the anode and may be protruded outwardly of edges of the anode, and the protruded portions may be bonded to each other to form a sealing part sealing a side of the anode.

According to an aspect of the present invention, there is provided a manufacturing method of a solid oxide fuel cell, the method including: forming a stacked body by alternately stacking an anode sheet and a reinforcing member; and stacking an electrolyte layer on one surface of the stacked body.

The forming of the stacked body may include stacking a plurality of the reinforcing members respectively having at least one slit formed therein so that directions of the at least one or more slits are alternated with each other.

The stacked body may have the electrolyte layer and the reinforcing member formed to have larger areas than that of the anode sheet and to be protruded outwardly of edges of the anode sheet.

The method may further include, after the stacking of the electrolyte layer, pressing and compressing the stacked body.

The compressing of the stacked body may include filling the slit of the reinforcing member with the anode sheet.

The compressing of the stacked body may include forming a sealing part sealing a side of the anode sheet by compressing and integrating portions protruded outwardly of the edges of the anode sheet

The method may further include, after the stacking of the electrolyte layer, disposing a dense plate formed of the same material as the reinforcing member and having at least one opening therein on one surface of the electrolyte layer or an external surface of the anode sheet.

The electrolyte layer, the reinforcing member, and the dense plate may be formed to have a larger area than that of the anode sheet and may be protruded outwardly of edges of the anode sheet, and the method may further include, after the disposing of the dense plate, forming a sealing part sealing a side of the anode sheet by compressing the protruded portions.

The method may further include, after the disposing of the dense plate, attaching a cathode to the electrolyte layer exposed in the opening of the dense plate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a solid oxide fuel cell according to an embodiment of the present invention;

FIG. 2 is a cross-sectional view taken along line A-A′ of FIG. 1;

FIG. 3 is an exploded perspective view of FIG. 1;

FIG. 4 is an exploded perspective view of an anode and a reinforcing member shown in FIG. 3;

FIG. 5 is a cross-sectional view taken along line B-B′ of FIG. 3; and

FIGS. 6 to 9 are views describing a manufacturing method of a solid oxide fuel cell according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

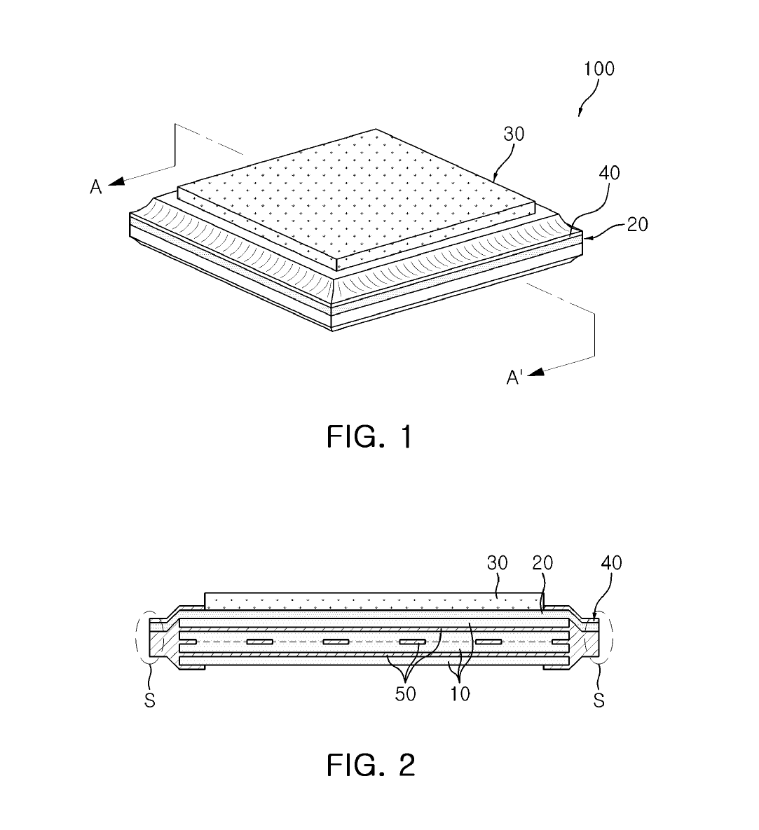

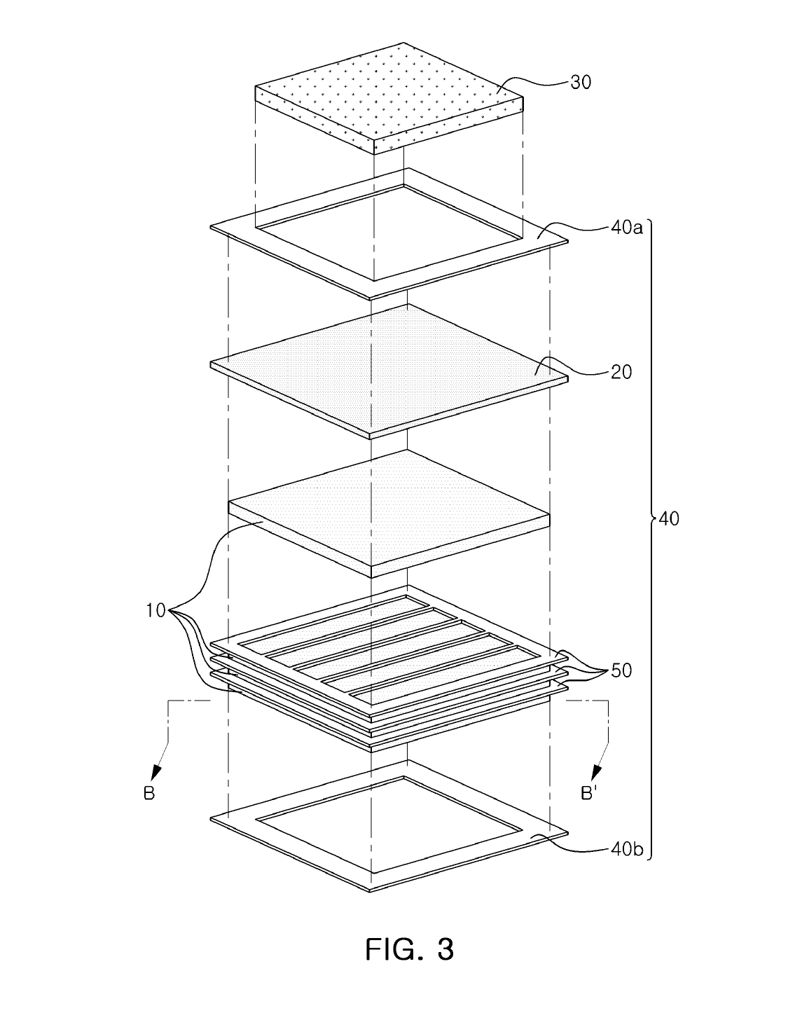

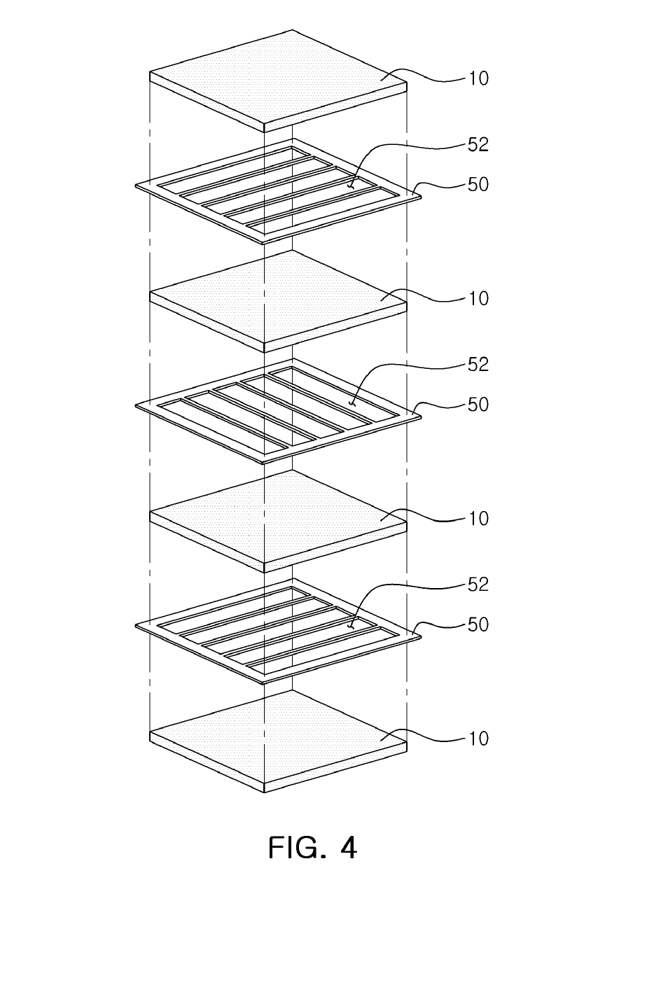

FIG. 1 is a perspective view schematically showing a solid oxide fuel cell according to an embodiment of the present invention, FIG. 2 is a cross-sectional view taken along line A-A′ of FIG. 1, and FIG. 3 is an exploded perspective view of FIG. 1.

Referring to FIGS. 1 to 3, a solid oxide fuel cell 100 according to an embodiment of the present invention includes a unit cell in which an anode 10, an electrolyte layer 20, a cathode 30, and a dense plate 40 are stacked. Here, in the unit cell, oxygen supplied through the cathode 30 electrochemically reacts with hydrogen supplied through the anode 10 to produce electricity.

The electrolyte layer 20 may be formed to have a flat plate shape, and specifically, may be formed to have a sheet shape.

Since the electrolyte layer 20 needs to serve a role in preventing a fuel introduced into the anode 10 from being leaked to the outside, the electrolyte layer 20 may be configured without having a micro clearance and pores or scratches therein. This electrolyte layer 20 may be formed of a solid oxide having ion conductivity. The electrolyte layer 20 may include a metal oxide such as yttria stabilized zirconia (YSZ) in which the yttria (Y₂O₃) is fused in the zirconia (ZrO₂) and the like. However, in the present invention, the material of the electrolyte layer 20 is not limited to YSZ, but the electrolyte layer 20 may be formed of various materials capable of functioning as the electrolyte layer 20 in addition to YSZ.

The cathode 30 may be disposed on one surface (for example, an upper surface) of the electrolyte layer 20.

The cathode 30 may be formed of a perovskite-based oxide, and more particularly, may be formed of lanthanum strontium manganese oxide (for example, LS_{0.84} Sr_{0.16}MnO₃) having a high degree of electron conductivity. In this case, in the cathode 30, the oxygen is converted into oxygen ions by LaMnO₃ so as to be delivered to the anode 10.

The anode 10 may be formed to have a generally flat sheet shape and may be disposed on the other surface (for example, a lower surface) of the electrolyte layer 20. The anode 10 may be formed of a material (NiO/YSZ cermet) in which a nickel oxide powder containing zirconia powder in an amount of 40% to 60% is sintered. Here, the nickel oxide is reduced to metallic nickel by hydrogen when producing electrical energy, thereby exhibiting electron conductivity.

In addition, the anode 10 according to the embodiment of the present invention includes at least one reinforcing member 50 therein.

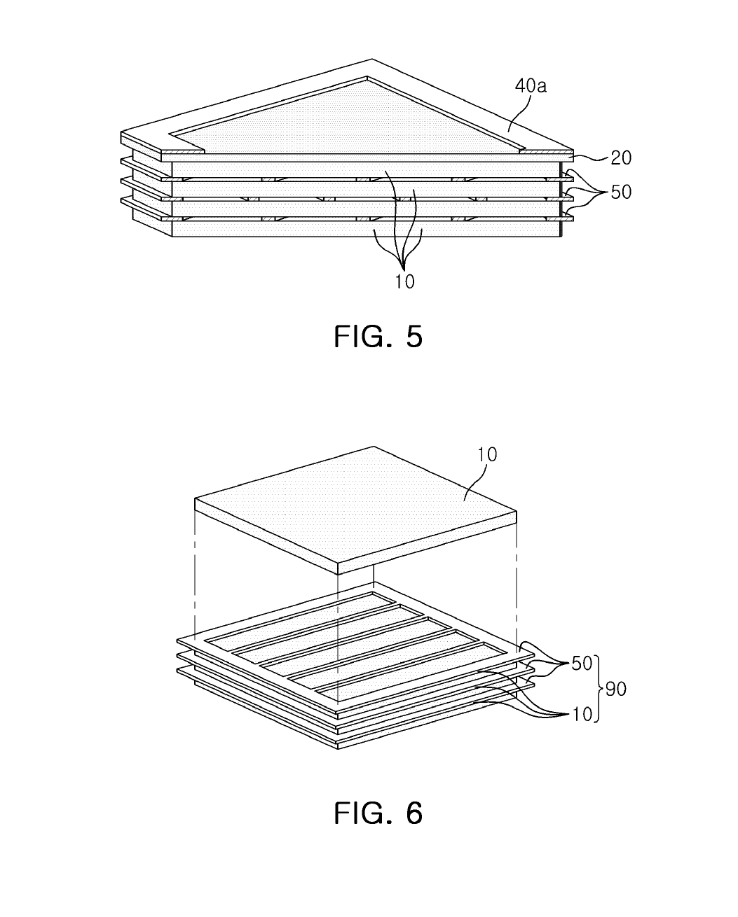

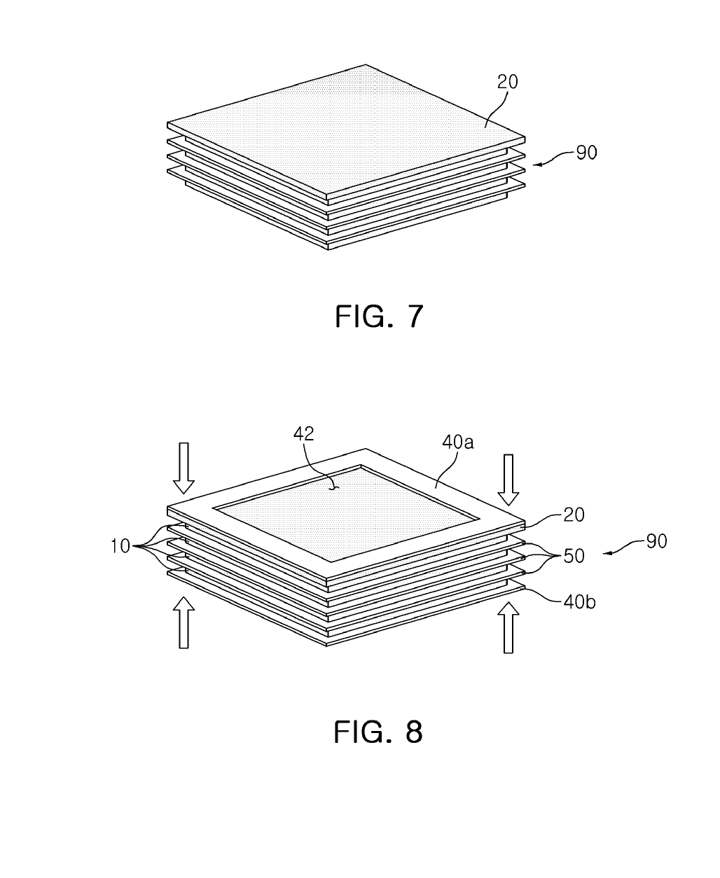

FIG. 4 is an exploded perspective view of an anode and a reinforcing member shown in FIG. 3 and FIG. 5 is a cross-sectional view taken along line B-B′ of FIG. 3. Here, FIG. 5 shows the anode 10 and the reinforcing member 50 in a state before the compression thereof, for convenience of explanation.

Referring to FIGS. 4 and 5, the reinforcing member 50 is interposed in the anode 10 so as to reinforce rigidity of the anode 10. To this end, the reinforcing member 50 may be formed of a metal oxide such as YSZ or the like having a higher degree of mechanical rigidity than the anode 10. For example, the reinforcing member 50 may be formed of a plurality of films formed of a dense 3˜5 YSZ. In addition, the reinforcing member 50 according to the embodiment of the present invention may be formed of the same material as the electrolyte layer 20.

The reinforcing member 50 according to the embodiment of the present invention may have at least one slit 52 formed therein, as shown in FIG. 4. In this case, the slit 52 may be filled with the anode 10. A plurality of the slits 52 may be formed to have the same width as each other or different widths from each other and may be disposed in parallel with each other. In addition, an interval between the slits 52 may be variously set, as needed.

Particularly, the reinforcing member 50 according to the embodiment of the present invention is disposed so as to be stacked in plural, wherein respective reinforcing members 50 may be stacked so that directions of the slits 52 alternate with each other.

Referring to FIG. 4, the reinforcing members 50 may be disposed and stacked such that length directions of the slit 52 of the reinforcing member 50 disposed at the lowest portion and the slit 52 of the reinforcing member 50 disposed thereover are perpendicular to each other.

As described above, the reinforcing members 50 are stacked so that the directions of the slits 52 are disposed in a zigzag form, such that the reinforcing member 50 may secure mechanical rigidity in all directions such that the overall strength of the anode 10 may be increased.

The dense plate 40 may be disposed at any one of an upper portion of the electrolyte layer 20 and a lower portion of the anode 10 as shown in FIGS. 2 and 3. The dense plate 40 is formed to have a size approximately similar to that of the above-mentioned reinforcing member 50 and has at least one opening 42 formed therein. Although the embodiment of the present invention shows a case in which one dense plate 40 is provided with only one opening 42, the present invention is not limited thereto, but the opening 42 may be formed in various amounts to have various forms, as needed.

In addition, the dense plate 40 may be formed of the same material as the reinforcing member 50 or the electrolyte layer 20. That is, the dense plate 40 may be formed of film formed of the dense 3˜5 YSZ.

This dense plate 40 may be divided into an upper dense plate 40a and a lower dense plate 40b according to a position thereof. In addition, the above-mentioned cathode 30 may be disposed in the opening 42 of the upper dense plate 40a. Therefore, the cathode 30 may be formed to have a shape corresponding to a shape of the opening 42 of the upper dense plate 40a so as to be attached to the electrolyte layer 20.

Meanwhile, the electrolyte layer 20, the reinforcing member 50, and the dense plate 40 described above may be formed to have a larger size than the anode 10. Therefore, the electrolyte layer 20, the reinforcing member 50, and the dense plate 40 may be formed in a manner in which they are further protruded toward edges of the anode 10, that is, peripheral portions of the anode 10. Further, the electrolyte layer 20, the reinforcing member 50, and the dense plate 40 may be bonded to one another at the outside of the anode 10 and may be integrally formed.

In this case, a part in which the electrolyte layer 20, the reinforcing member 50, and the dense plate 40 are bonded to one another forms a sealing part S sealing a side of the anode 10.

As described above, the electrolyte layer 20, the reinforcing member 50, and the dense plate 40 are bonded to one another at the outside of the anode 10, such that the anode 10 and the cathode 30 may be completely separated from each other and the side of the anode 10 may be very firmly sealed.

Meanwhile, although the embodiment of the present invention shows a case in which the sealing part S is formed by the electrolyte layer 20, the reinforcing member 50, and the dense plate 40, the present invention is not limited thereto. For example, the sealing part S may also be formed only by the reinforcing member 50 and the dense plate 40 or only by the electrolyte layer 20 and the dense plate 40. In addition, in the case in which the reinforcing member 50 is disposed at both of upper and lower portions of an anode stacked body, the reinforcing member 50 may serve as the dense plate 40. In this case, the sealing part S may be formed only by the reinforcing member 50.

In addition, the solid oxide fuel cell 100 according to the embodiment of the present invention may include a current collector (not shown) coupled to the electrodes 10 and 30 (that is, the anode and the cathode). Thereby, electricity generated from the unit cell may be supplied to an external apparatus or circuit through an anode current collector and a cathode current collector.

As a material of the current collector, a single metal such as nickel (Ni) may be used, and a cermet in which metal and ceramic are mixed may be used. For example, the current collector may be a mixture of Ni, a Ce-based oxide, and a YSZ-based oxide or Ni, a Ce-based oxide, and a YSZ-based oxide.

Next, a manufacturing method of a solid oxide fuel cell according to an embodiment of the present invention will be described.

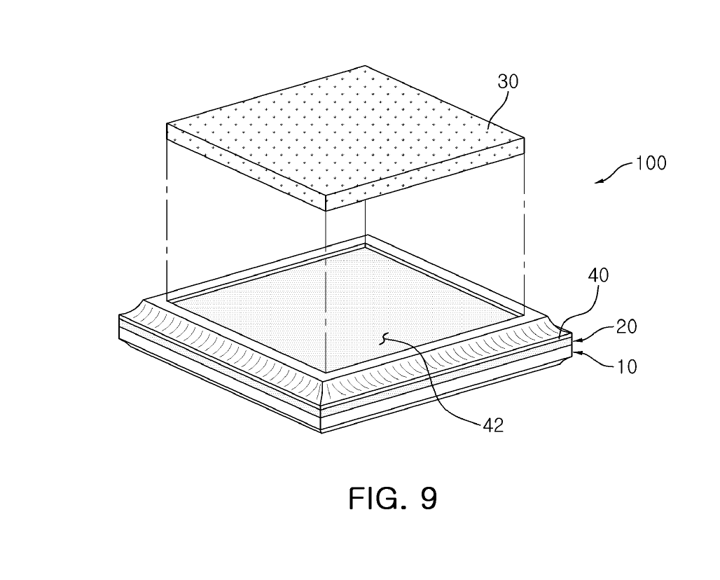

FIGS. 6 to 9 are views describing a manufacturing method of a solid oxide fuel cell according to an embodiment of the present invention.

Referring to FIGS. 6 to 9, in the manufacturing method of the solid oxide fuel cell 100, an anode sheet 10 and the reinforcing member 50 are first alternately disposed with each other. In this case, as described above, the reinforcing members 50 disposed to be adjacent to each other may be disposed so that the directions of the slits alternate with each other.

Here, the anode sheet 10 and the reinforcing member 50 may be formed in plural, and the reinforcing member 50 is formed to be larger than the anode sheet 10 and may be disposed so that all sides thereof are protruded outwardly of the anode sheet 10.

Next, as shown in FIG. 7, the electrolyte layer 20 is disposed on a stacked body 90 in which the anode 10 and the reinforcing member 50 are stacked. In this case, the electrolyte layer 20 may be formed to have approximately the same size as the reinforcing member 50, and as a result, the electrolyte layer 20 may be disposed to cover the entire upper surface of the stacked body 90.

Next, as shown in FIG. 8, the dense plate 40 is disposed on the upper portion of the electrolyte layer 20 and a lower surface of the stacked body 90 in which the anode 10 and the reinforcing member 50 are stacked. In this case, the dense plate 40 may also be formed to have approximately the same size as the reinforcing member 50. Therefore, the dense plate 40 may be disposed in a manner in which it covers all edges of the electrolyte layer 20 or the reinforcing member 50.

Next, as shown in FIG. 9, the stacked body 90, having the electrolyte layer 20 and the dense plate 40 stacked thereon, is compressed.

In the compression process, the anode 10 is pushed into an inside of the slit of the reinforcing member 50 so as to fill the inside of the slit. In addition, in this process, the anode 10, as well as the electrolyte layer 20, the dense plate 40, and the reinforcing member 50 protruded toward the outer side of the anode 10, that is, the outside of the anode 10, are pressurized toward the center upwardly and downwardly.

Therefore, respective portions of the electrolyte layer 20, the dense plate 40 and the reinforcing member 50 are protruded outwardly of the anode 10 in contact each other and integrally attached. As a result, the sealing part (S of FIG. 2) is formed by the electrolyte layer 20, the reinforcing member 50, and the dense plate 40 at the outer side of the anode 10, that is, the outside of the edge.

Next, a process of attaching a cathode 30 to the electrolyte layer 20 and simultaneously firing the cathode 30 and the electrolyte layer 20 may be performed. Through these processes, the unit cell of the solid oxide fuel cell 100 according to the embodiment of the present invention shown in FIG. 1 is completed.

Meanwhile, although the embodiment of the present invention illustrates the case of the electrolyte layer 20 having the cathode 30 stacked thereon and then being fired, the present invention is not limited thereto. The present invention may be variously applied, as needed. That is, the firing may be performed after the compressing process and the cathode 30 may be then stacked.

As set forth above, according to the embodiment of the present invention, the solid oxide fuel cell may have the reinforcing member disposed within the anode. Therefore, even when the anode is used as a support structure, the mechanical rigidity thereof may be secured.

In addition, the plurality of reinforcing members and the anode sheets may be alternately stacked, and the reinforcing members may be alternately disposed so that the slits formed therein alternate with each other. Therefore, a higher degree of strength than the case in which only one reinforcing member is used may be secured.

In addition, as set forth above, according to the embodiment of the present invention, the solid oxide fuel cell has the reinforcing member configuring the frame of the anode and fixing the form of the anode, such that it may prevent the stacked body from being bent upwardly and downwardly during the sintering process.

In addition, as set forth above, in the manufacturing method of the solid oxide fuel cell according to the embodiment of the present invention, the reinforcing member, the dense plate, and the electrolyte layer may be formed using the relatively dense material, thereby sealing the side of the anode. Therefore, unlike the related art in which a separate sealing material is applied to the side of the anode, the side of the anode is directly sealed using the reinforcing member, the dense plate, and the electrolyte layer, such that it may more firmly seal the anode and the cathode than in the case of the related art.

In addition, the sealing part may be formed only using the compressing and firing processes without separately applying the sealing material as in the related art, such that the manufacturing process may be simplified.

While the present invention has been shown and described in connection with the embodiments, it will be apparent to those skilled in the art that modifications and variations can be made without departing from the spirit and scope of the invention as defined by the appended claims.

For example, although the foregoing embodiments of the present invention illustrate the flat-shaped solid oxide fuel cell, the present invention is not limited thereto, but may be variously applied. For example, the present invention may be applied to a tube-shaped solid oxide fuel cell.

In addition, although the foregoing embodiments illustrate the case in which the reinforcing member is provided with a through hole in a slit shape, the present invention is not limited thereto, but may be variously applied. For example, the through hole may be formed in a curved shape formed to be elongated or bent.

What is claimed is:

1. A solid oxide fuel cell, comprising:
an electrolyte layer;
a cathode provided on one surface of the electrolyte layer;
an anode provided on the other surface of the electrolyte layer; and
at least one reinforcing member disposed within the anode to reinforce rigidity thereof.

2. The solid oxide fuel cell of claim 1, wherein the reinforcing member is formed of a material having a higher degree of mechanical rigidity than that of the anode.

3. The solid oxide fuel cell of claim 2, wherein the electrolyte layer and the reinforcing member are formed of the same material.

4. The solid oxide fuel cell of claim 2, wherein the anode is formed of NiO/YSZ, and the reinforcing member is formed of 3˜5 YSZ.

5. The solid oxide fuel cell of claim 1, wherein the reinforcing member has at least one slit formed therein.

6. The solid oxide fuel cell of claim 5, wherein the reinforcing member is a plurality of reinforcing members included in the anode, the plurality of reinforcing members being stacked and disposed so that directions of the at least one or more slits are alternated with each other.

7. The solid oxide fuel cell of claim 1, wherein the electrolyte layer and the reinforcing member are formed to have larger areas than that of the anode and are protruded outwardly of edges of the anode, the protruded portions being bonded to each other to form a sealing part sealing a side of the anode.

8. The solid oxide fuel cell of claim 1, further comprising a dense plate disposed at any one of one surface of the electrolyte layer and an external surface of the anode, and formed of the same material as the reinforcing material.

9. The solid oxide fuel cell of claim 8, wherein the electrolyte layer, the reinforcing member, and the dense plate are formed to have a larger area than that of the anode and are protruded outwardly of edges of the anode, the protruded portions being bonded to each other to form a sealing part sealing a side of the anode.

10. The solid oxide fuel cell of claim 8, wherein the dense plate includes at least one opening and the cathode is attached to the electrolyte layer in the opening.

11. A solid oxide fuel cell, comprising:
an electrolyte layer;
a cathode provided on one surface of the electrolyte layer;
an anode provided on the other surface of the electrolyte layer; and
a dense plate disposed on one surface of the electrolyte layer and an external surface of the anode,
wherein the electrolyte layer and the dense plate are formed to have a larger area than that of the anode and are protruded outwardly of edges of the anode, the protruded portions being bonded to each other to form a sealing part sealing a side of the anode.

12. A manufacturing method of a solid oxide fuel cell, the method comprising:
forming a stacked body by alternately stacking an anode sheet and a reinforcing member; and
stacking an electrolyte layer on one surface of the stacked body.

13. The method of claim 12, wherein the forming of the stacked body includes stacking a plurality of the reinforcing members respectively having at least one slit formed therein so that directions of the at least one or more slits alternate with each other.

14. The method of claim 12, wherein the stacked body has the electrolyte layer and the reinforcing member formed to have larger areas than that of the anode sheet and to be protruded outwardly of edges of the anode sheet.

15. The method of claim 14, further comprising, after the stacking of the electrolyte layer, pressing and compressing the stacked body.

16. The method of claim 15, wherein the compressing of the stacked body includes filling the slit of the reinforcing member with the anode sheet.

17. The method of claim 15, wherein the compressing of the stacked body includes forming a sealing part sealing a side of the anode sheet by compressing and integrating portions protruded outwardly of the edges of the anode sheet.

18. The method of claim 12, further comprising, after the stacking of the electrolyte layer, disposing a dense plate formed of the same material as the reinforcing member and having at least one opening therein on one surface of the electrolyte layer or an external surface of the anode sheet.

19. The method of claim 18, wherein the electrolyte layer, the reinforcing member, and the dense plate are formed to have a larger area than that of the anode sheet and are protruded outwardly of edges of the anode sheet, and the method further includes, after the disposing of the dense plate, forming a sealing part sealing a side of the anode sheet by compressing the protruded portions.

20. The method of claim 18, further comprising, after the disposing of the dense plate, attaching a cathode to the electrolyte layer exposed in the opening of the dense plate.
